(19) United States
(12) Patent Application Publication
(10) Pub. No.: US 2006/0188859 A1
(43) Pub. Date: Aug. 24, 2006

(54) Method and system for computer implemented personal counseling

(76) Inventor: Haim Yakobi, Kfar-Saba (IL)

Correspondence Address: NATH & ASSOCIATES, 1030 15TH STREET, NW, 6TH FLOOR, WASHINGTON, DC, 20005, US

(21) Appl. No.: 11/061,721

(22) Filed: Feb. 22, 2005

(51) Int. Cl. G09B 19/00

(52) U.S. Cl. 434/238; 434/323

(57) ABSTRACT

A method and system for personal counseling of a individual interested in overcoming an obstacle in order to achieve a personal goal. The method comprises transmitting over a communications network from a host computer to a communication device data relating to an audio-video clip in which an overcomer relates an experience in which the overcomer overcame the obstacle. The video clip is displayed on a display screen of the communication device. The system comprises a host computer having a memory storing therein data indicative of one or more video clips wherein in each video clip an overcomer relates an experience in which the overcomer overcame an obstacle. The host computer is configured to transmit over a communications network the data indicative of one or more of the video clips to a communication device and to cause the communication device to show the one or more video clips on a display screen of the communication device.

### FIELD OF THE INVENTION

The present invention relates to methods of computer-implemented multi-media counseling.

### BACKGROUND OF THE INVENTION

People are known to be unhappy due to their present circumstances and their inability to overcome obstacles preventing them from altering their circumstances. In such cases, personal counseling may be effective in motivating a person to adopt desirable behavior in order to overcome these obstacles and achieve a personal goal. U.S. Pat. No. 5,813,863, for example, discloses a multimedia system for modifying high-risk behavior such as smoking or eating disorders. The system includes an “interactive/contextual adventure” in which an individual at a computer terminal is presented with a video clip describing a hypothetical scenario and is queried how he would behave in the described circumstances. He is then presented with the consequences of his chosen behavior. The “adventure” thus gives the individual a first hand virtual experience of the cause and effects of his habits and behaviors.

### SUMMARY OF THE INVENTION

The present invention provides a multimedia method and system for personal counseling of an individual is interested in achieving a personal goal but first has to perform one or more tasks in order to achieve the personal goal. The task or tasks that the individual must perform in order to reach his or her personal goal is referred to herein as the “obstacle” that the individual must “overcome”. For example, the personal goal may be adopting a more healthful diet in which case the obstacle may be modification of eating habits. As another example, the personal goal may be ceasing to indulge in a vice, in which case the obstacle may be overcoming addiction to the vice. As yet another example, the personal goal may be a happier marriage, in which case the obstacle would be solving marital problems. As still a further example, the personal goal may be to be free of a particular medical condition, in which case the obstacle would be overcoming the medical condition.

A person who has overcome an obstacle, and thus achieved a personal goal, is referred to herein as an “overcomer”. In accordance with the invention, an individual who must overcome an obstacle in order to achieve a personal goal is exposed to the experience of an overcomer of the same obstacle by watching a video clip in which the overcomer describes the obstacle he or she faced and explains how he or she overcame the obstacle.

The system includes one or more communication devices equipped with a display screen. The system also includes a server or host computer having a memory storing data indicative of one or more video clips in which an overcomer describes the obstacle he or she faced and explains how he or she overcame the obstacle. Data indicative of a video clip stored in the memory of the server or host computer is transmitted over a communications network to one of the communication devices of the system. The communication devices may be stationary or portable. The video clip may then be displayed on the display screen of the communication device. The communications network may be for example a computer network such as a local area network, a wide area network, or the Internet. In this case, the communication devices are computer terminals, such as a personal computer (PC), a personal digital assistant (PDA), a cellular telephone having a display screen and configured to communicate over the communications network, or a television configured to communicate over the communications network. The communication network may also be a cellular telephone network, in which case the communication devices are cellular phones or other devices having a display screen and configured to communicate over a cellular network. The network may also be an electrical voltage grid, in which case the communication devices are capable of communicating over this type of network.

In a preferred embodiment, an introductory module of the software displays on the display screen of one of the communication devices a main menu of categories of personal goals. The individual selects from the main menu a category and a second menu listing personal goals in the selected category is then displayed on the display. The individual selects a personal goal from the second menu and a listing of video clips relating to the selected personal goal is then displayed on the display device. In each video clip, an overcomer recounts his personal story of how he overcame the same obstacles the individual presently faces and succeeded in achieving the selected personal goal.

The first person perspective is the key to the “learning from others” approach of the present invention. When information is presented in the context of a first hand experience, learning is greatly facilitated. The individual senses and evaluates each situation in the video clip through the ears and eyes of the overcomer. Because the overcomer was previously in the same situation that the individual presently finds himself in, the individual identifies with the overcomer. The individual continues to identify with the overcomer as the overcomer describes how he or she overcame the same obstacles that the individual presently faces.

The video clips of the present invention may be prepared using any appropriate multimedia authoring program, preferably having the capability of creating executable files that can be run on as many computing platforms as possible (especially a generic personal computer platform). “Macromedia Director” from Macromedia, Inc., and similar software from Microsoft and other sources incorporate the necessary features and qualities. This software allows the multimedia developer to develop the video clips in the form of “cast members” e.g. multimedia clips which may include text pages, pictures, graphics, buttons, digital sound files, digital video files, palettes and scripts. The scripts are small executable programs that are related to particular objects and are executed as the result of an event such as clicking a mouse button, pressing a key, touching a screen, etc.

Thus, in its first aspect, the invention provides a method for personal counseling of an individual interested in overcoming an obstacle in order to achieve a personal goal, the method comprising transmitting over a communications network from a host computer to a communication device data relating to an audio-video clip in which an overcomer relates an experience in which the overcomer overcame the obstacle, and displaying the audio-video clip on a display screen of the communication device.

In its second aspect, the invention provides a system for counseling an individual over a computer network, comprising:
(a) a communications network;
(b) one or more communication devices, each communication device having a display screen; and
(c) a host computer having a memory storing therein data indicative of one or more video clips wherein in each video clip an overcomer relates an experience in which the overcomer overcame an obstacle, the host computer being configured to transmit over the communications network the data indicative of one or more of the video clips to a communication device and causing the communication device to show the one or more video clips on the display of the communication device.

In its third aspect, the invention provides a program storage device readable by machine, tangibly embodying a program of instructions executable by the machine to perform method steps for personal counseling of an individual interested in overcoming an obstacle in order to achieve a personal goal, the method comprising transmitting over a communications network from a host computer to a communication device data relating to an audio-video clip in which an overcomer relates an experience in which the overcomer overcame the obstacle, and displaying the audio-video clip on a display screen of the communication device.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a system for counseling in accordance with one embodiment of the invention;

FIG. 2 is a flow chart diagram of a method of counseling network in accordance with one embodiment of the invention; and

FIG. 3 shows menu screens of audio-video clips.

### DETAILED DESCRIPTION OF A PREFERRED EMBODIMENT

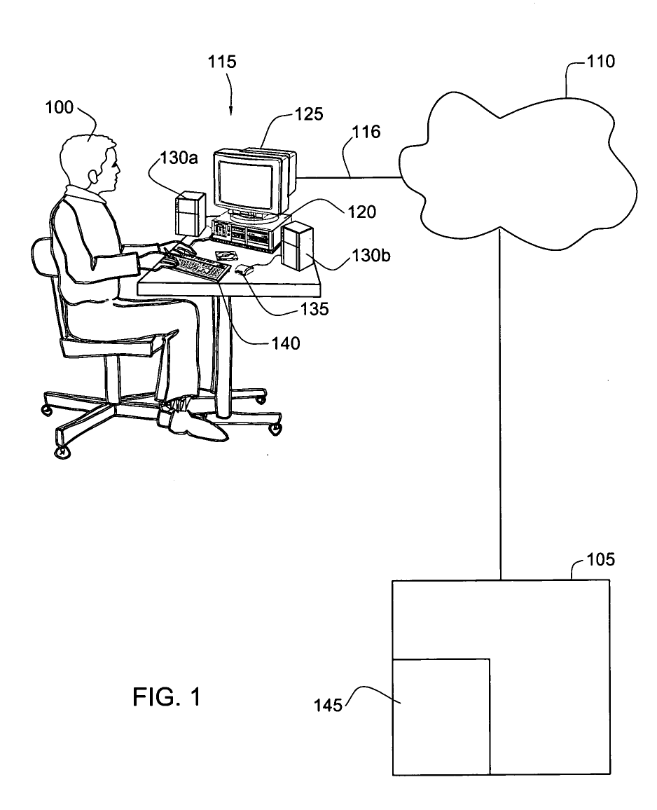

Referring first to FIG. 1, an embodiment of the invention is shown in which a communication device 115 is connected to a server or host computer 105 over a communications network represented by the cloud 110. The communication network may be a computer network such as the Internet, a local area network, or a wide area network. Alternatively, the communication network may be a wired or wireless telephone network or an electrical voltage grid. In the embodiment of FIG. 1, the communication network is a computer network and the communication device 115 is a personal computer terminal connected to the network 110 via a communication line 116 that may be a wired or wireless connection. This is by way of example only, and the communication device may be any stationary or portable device such as a cellular phone having a display screen and access to the network 110.

The computer terminal 115 may be, for example, a conventional personal computer and the CPU/Internal Components 120 of the terminal 115 may be those which are commonly integrated therein, such as an Intel Pentium device. The computer terminal may also be a portable communications device (not shown), such as a cellular telephone having a display screen and access to the communications network 110.

The computer terminal 115 also includes a monitor/video output device 125 which can be a conventional monitor such as an SVGA monitor preferably with 800×600 pixel resolution or higher. The monitor 125 is attached via a serial port to the CPU 120. An audio output is also provided, and this may comprise an input/output board which allows the CPU 120 to send sounds, including voice and music, to the individual via headphones, earphones or speakers 130a and 130b.

An individual 100 may use any computer input device such as a mouse 135 or a keyboard 140. Hard disk storage is a commercially available disk drive or any drive that can store data attached via known IDE or SCSI interfaces to the CPU 120.

The host computer 105 has memory storage 145 for storing executable files to be downloaded to the hard disk storage of the individual's CPU 120 and for maintaining other necessary files such as software for playing MPEG compressed full-motion video clips on the individual's computer terminal 115.

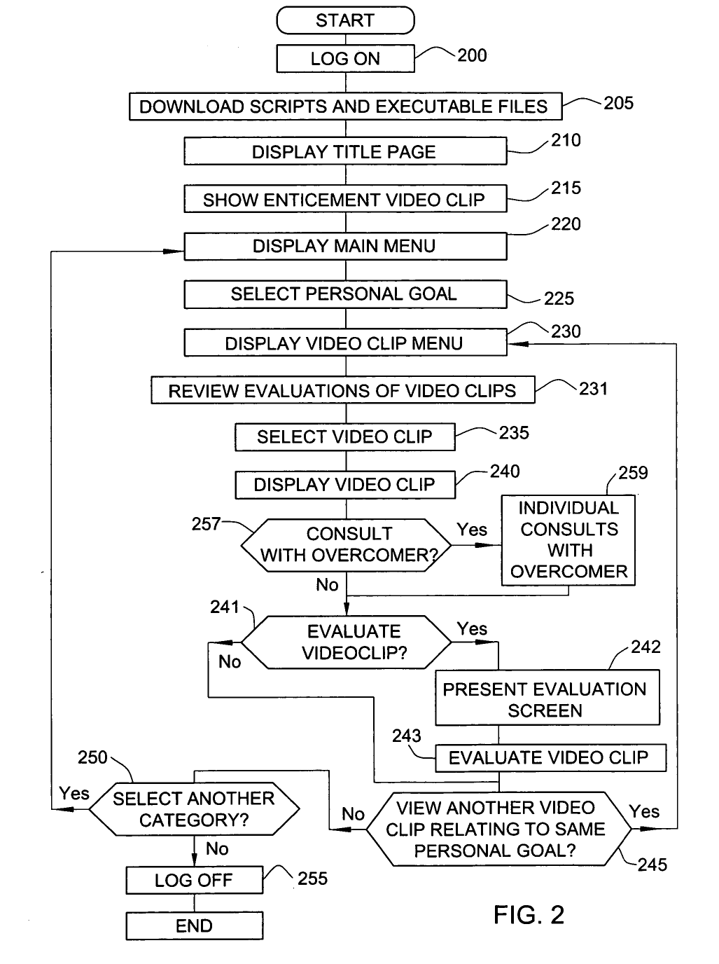

FIG. 2 is a flow chart diagram of steps of the method of the invention. In log-on step 200, the individual's computer terminal 115 is connected to the host computer 105. The necessary data scripts and executable files are then downloaded from the host computer 105 to the individual's computer terminal over the computer network 110 (step 205). The main executable files are a standard Windows application that can be run on any PC platform. The executable files are copied to the CPU 120 and are run.

In the log-on step 200, the individual may be asked to input a user name and password as well as information relating to such factors as age, gender, etc. As described below, this information may be used to provide a video clip appropriate for the individual.

At step 210, a title page is displayed. The text and graphics may also include any appropriate introductory topic matter such as company name, copyright information, patent information, etc.

The program then proceeds to an enticement step 215, which generally includes a teaser video clip designed to capture the individual's attention. A voice-over may describe the program, outline the various personal goals, and acclimate the individual to the software. The language and images are preferably selectable by the individual, so that the individual identifies with the images shown in the video clip.

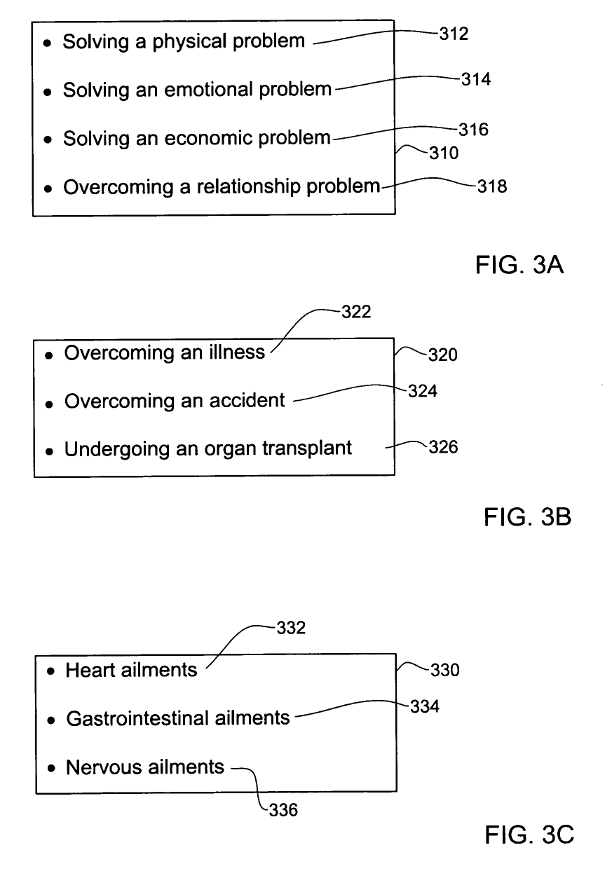

In step 220, the individual 100 is presented with a menu of personal goals. In a preferred embodiment, the menu of personal goals is presented to the individual in the form of a tree, in which the personal goals are arranged in a hierarchy of categories. In this case, the individual 100 may select a personal goal by browsing the tree. For example, as shown in FIG. 3a, a first screen 310 maybe presented to the individual displaying a list of topic categories, that may be, for example, “solving a physical problem” 312, “solving an emotional problem” 314, “solving an economic problem” 316, “solving a relationship problem” 318, and so on. The individual 100 can then select one of the categories, for example “solving a physical problem” 312, by choosing an option on his monitor 125 or inputting a selection using his or her keyboard or by clicking on the selection with the mouse 135. Then, as shown in FIG. 3b, the individual is presented with a screen of subcategories of the selected category. If the individual, for example, selected the category “solving a physical problem” 312 from the screen 310, the individual may be presented with a screen 320 displaying the subcategories “overcoming an illness” 322, “overcoming an accident” 324, or “undergoing an organ transplant” 326. The individual then selects the subcategory of interest to him or her. At this point, the individual may be presented with a screen displaying sub-subcategories. For example, as shown in FIG. 3c, if the individual selected the subcategory “overcoming an illness” 322 from the screen 320, the individual may be presented with a screen 330 displaying a list of types of illnesses, such as “heart ailments” 332, “gastrointestinal ailments” 334, “nervous ailments” 336 and so on. The individual selects the sub-subcategory. This process may be repeated any number of times, each time the individual selecting a category from a screen of categories after which he is presented with a subsequent screen of sub-categories. There may be any number of branching generations in the tree. The individual may stop browsing the tree at any level in the tree, and select a category at that level.

After having selected the personal goal (step 225), a video clip menu is displayed showing a list of video clips relating to the selected personal goal (step 230). If, for example, the individual selected “solving a physical problem” 312 from the screen 310, and did not select any subcategories, the individual would be presented with a video clip menu screen displaying some or all of the available video clips relating to “solving a physical problem”. If the individual selected “solving a physical problem” 312 from the screen 310, and then selected the subcategory “overcoming an illness” 322 from the screen 320, and did not select any of the sub-subcategories of the screen 330, he would be presented with a video clip menu screen displaying some or all of the available video clips relating to “overcoming an illness”. The set of available video clips relating to “overcoming an illness” would be a subset of the set of clips relating to “solving a physical problem”. Thus, the more specifically the individual defines the personal goal about which he wishes to view video clips (i.e. the further down he or she goes in the menu tree), there will typically be a smaller the number of video clips relevant to the chosen personal goal.

Before a video clip is selected from the video clip menu, the individual may request to view any evaluations of one or more of the video clips in the video clip menu (step 231). The evaluations are typically offered by previous viewers of the video clip. A video clip is then selected from the menu (step 235). The video clip is then displayed on the monitor 125 of the individual's computer terminal 115 (step 240).

In a preferred embodiment of the invention, after the individual has viewed the video clip, the individual is provided with an option of consulting with an overcomer, who thus serves as a consultant. Thus, at step 257 the individual is queried as to whether he or she is interested in consulting with an overcomer. If yes, then at step 259, the individual selects an overcomer and consults with the consultant. The consultant may be chosen according to the obstacle that the overcomer has overcome and may be reached via chat. Consulting with the consultant may involve the individual scheduling a session with the consultant's diary. In this case, the individual checks when the consultant is available, notes the consultant's fee, and requests a session of a certain length. The consultant confirms the order of a session and opens a window at the requested time. The individual confirms the beginning of the session, which can be conducted via video chat, text chat, audio chat or any combination of the above. Following the consultation with the consultant, the individual can express his or her personal opinion and rank the consultant.

At the end of the consultation or if the individual indicated at step 257 that he or she is not interested in consulting with an overcomer, the individual is queried in step 241 as to whether he wishes to evaluate the video clip. If yes, then in step 242 the individual is presented with an evaluation screen. The individual may use one or more of the input devices to assign one or more numerical scores to the video, and possibly input a remark on the video clip (step 243). If, at step 241, the individual indicates that he or she is not interested in evaluating the video clip, or after reviewing the video clip in step 243, the individual is queried in step 245 as to whether he or she wishes to view another video clip relating to the same personal goal. If yes, the method returns to step 230 with the video clip menu being displayed on the monitor 125. If no, the individual is queried as to whether he or she wishes to view a video clip relating to a different personal goal (step 250). If yes, the method returns to step 220 with the main menu being displayed on the monitor 125. If no, the individual logs off in step 255 and the method terminates.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for personal counseling of an individual interested in overcoming an obstacle in order to achieve a personal goal, the method comprising transmitting over a communications network from a host computer to a communication device data relating to an audio-video clip in which an overcomer relates an experience in which the overcomer overcame the obstacle, and displaying the audio-video clip on a display screen of the communication device or an electrical voltage grid.

2. The method of claim 1 wherein the communication network is a computer network, a wired telephone network, a wireless telephone network.

3. The method of claim 1 wherein the communication network is a computer network selected from a local access network, a wide access network or the Internet.

4. The method of any one of the previous claims wherein the communication device is a computer terminal, a telephone, a personal digital assistant (PDA), or a television.

5. The method of any one of the previous claims, wherein the personal goal is selected from:
(a) overcoming a physical problem;
(b) overcoming an emotional problem;
(c) overcoming an economic problem; and
(d) overcoming a relationship problem.

6. The method of any one of claims 1 to 5 further comprising a step of showing a teaser video clip.

7. The method of any one of the previous claims further comprising evaluating a video clip displayed on the display screen.

8. The method according to any one of the previous claims further comprising a consultation between the individual and an overcomer.

9. A system for counseling an individual over a computer network, comprising:
(a) a communications network;
(b) one or more communication devices, each communication device having a display screen; and
(c) a host computer having a memory storing therein data indicative of one or more video clips wherein in each video clip an overcomer relates an experience in which the overcomer overcame an obstacle, the host computer being configured to transmit over the communications network the data indicative of one or more of the video clips to a communication device and causing the communication device to show the one or more video clips on the display of the communication device.

10. The system of claim 9 wherein the communication network is a computer network, a wired telephone network, or a wireless telephone network or an electrical voltage grid.

11. The system of claim 10 wherein the communication network is a computer network selected from a local access network, a wide access network or the Internet.

12. The system of any one of claims 9 to 11 wherein the communication device is a computer terminal, a telephone, a personal digital assistant (PDA), or a television.

13. The system of any one of the previous claims, wherein the personal goal is selected from:
(a) overcoming a physical problem;
(b) overcoming an emotional problem;
(c) overcoming an economic problem; and
(d) overcoming a relationship problem.

14. The system of any one of claims 9 to 13 wherein the host computer has a memory storing therein data indicative of one or more teaser video clips, and the host computer is further configured to transmit to a communication device the data indicative of one or more of the teaser video clips to a communication device and causing the communication device to show the one or more teaser video clips on the display of the communication device.

15. The system of any one of claims 9 to 14 wherein the host computer is further configured to receive and store data indicative of an evaluation of one of the video clips, and to transmit to a communication device the data indicative of an evaluation of a video clip and causing the communication device to display the evaluation on the display of the communication device.

16. A program storage device readable by machine, tangibly embodying a program of instructions executable by the machine to perform method steps for personal counseling of an individual interested in overcoming an obstacle in order to achieve a personal goal, the method comprising transmitting over a communications network from a host computer to a communication device data relating to an audio-video clip in which an overcomer relates an experience in which the overcomer overcame the obstacle, and displaying the audio-video clip on a display screen of the communication device.
